(19) United States
(12) Patent Application Publication
(10) Pub. No.: US 2011/0187034 A1
(43) Pub. Date: Aug. 4, 2011

(54) Cushion, Bedding and Seating Surface Assemblies

(76) Inventors: Dennis Beard, Holland, MI (US); Scott Hain, Orchard Park, NY (US)

(21) Appl. No.: 12/852,089

(22) Filed: Aug. 6, 2010

Related U.S. Application Data
(60) Provisional application No. 61/273,592, filed on Aug. 6, 2009.

(51) Int. Cl. F16F 3/00; F16F 3/10

(52) U.S. Cl. 267/143

(57) ABSTRACT

A cushioning assembly (i.e., for bedding, chairs, sofas, couches among other surfaces which require or benefit from cushioning) which includes a plurality of springs and fiber bundles. The plurality of springs are disposed at predetermined locations. The fiber bundles are cooperatively associated with the plurality of springs. The fiber bundles are disposed into association with the plurality of springs. Subsequently, they are integrated through a heating process with the plurality of springs and each other.

### CROSS-REFERENCE TO RELATED APPLICATION

This application claims priority from U.S. Provisional Pat. App. Ser. No. 61/273,592 filed Aug. 6, 2009, entitled Cushion, Bedding and Seating Surface Assemblies, the entire specification of which is hereby incorporated by reference.

### BACKGROUND OF THE DISCLOSURE

1. Field of the Disclosure

The disclosure relates in general to seating surfaces, and more particularly, to bedding, cushion and seating surface assemblies having improved performance. It will be understood that while bedding is referenced, the invention is not limited to bedding and the principles of the invention are equally applicable to general cushions used in, for example, furniture, seating, and other areas. Thus, while bedding is referenced, it will be understood that bedding shall refer to bedding, per se, as well as cushions and other seating surfaces, without limitation.

2. Background Art

The use of performance materials for bedding is known in the art. Conventionally, a spring based system is utilized for bedding, or a cut foam based system. With respect to the former, most such beds rely on a plurality of separate or integrally coupled springs that provide the cushioning and biasing. These springs are coupled to each other to form a frame, or, in other embodiments, are separately encased in, for example, a fabric sleeve. Cushioning elements and covers extend over the top, bottom and side surfaces. Certain of these beds may include a pillow top.

Other commonly utilized bedding materials comprise foam members, such as memory foam members, or conventional urethane foam members. Such bedding typically is substantially solid throughout and substantially uniform. Typically, such beds, while they may include a frame member, are typically void of any structural support other than the foam.

It will be understood that while bedding is described, the same principles can be applied to other seating and support surfaces, such as chairs, couches, sofa's, and the like.

While each has its advantages, it has been found that springs in cooperation with fiber bundles of the type disclosed and set forth in co-pending U.S. patent application Serial No. 12/004,560, filed Dec. 21, 2007, entitled “SYSTEM AND METHOD OF FORMING AN ARTICLE, AND AN ARTICLE FORMED THEREBY,” has advantages in performance over either type of conventional bedding. This pending application is hereby incorporated by reference in its entirety.

Thus, it is an object of the invention to formulate bedding solutions that incorporate both springs and fiber bundles.

### SUMMARY OF THE DISCLOSURE

The present disclosure is directed to a cushioning assembly (i.e., for bedding, chairs, sofas, couches among other surfaces which require or benefit from cushioning) which includes a plurality of springs and fiber bundles. The plurality of springs are disposed at predetermined locations. The fiber bundles are cooperatively associated with the plurality of springs. The fiber bundles are disposed into association with the plurality of springs. Subsequently, they are integrated through a heating process with the plurality of springs and each other.

In a preferred embodiment, the plurality of springs includes a first end and a second end. The fiber bundles couple the first end of the springs and the second end of the springs.

In another preferred embodiment, the plurality of springs further includes an inner spring region. The fiber bundles are substantially precluded from being positioned within the confines of the spring.

In another preferred embodiment, the plurality of springs are positioned substantially in a rectangular grid-like configuration.

Preferably, the cushioning assembly further includes a manifold coupled to an HVAC system. The manifold is placed in communication with the inner spring region of the plurality of springs, to, in turn, provide conditioned air thereto.

In another preferred embodiment, the plurality of springs comprise helically wound springs.

Preferably, at least one of the plurality of springs is preloaded.

In another preferred embodiment, the cushioning assembly includes a top surface topography. The top surface topography has a plurality of bumps corresponding to the placement of the plurality of springs. This, in turn, facilitates the movement of the springs along an initial distance of travel substantially independently of other springs.

In another preferred embodiment, the composition of the fiber bundles can be varied throughout the cushioning assembly.

Preferably, in such an embodiment, a more compressible fiber bundle is positioned in proximity of at least one of the edges of the cushioning assembly and wherein a relatively less compressible fiber bundle is positioned in a central region of the cushioning assembly.

In a preferred embodiment, fiber bundles that extend between respective ones of the plurality of springs can be cut to facilitate substantially independent movement of the respective ones of the plurality of springs.

In another preferred embodiment, the fiber bundles comprise a plurality of fiber tows which are extended at least one of longitudinally and laterally through and between the respective ones of the plurality of springs.

In another preferred embodiment, the fiber bundles extend about at least one end of the plurality of springs. A top layer of fiber bundles extending over the at least one end of the plurality of springs. The fiber bundles coupled to the springs and the top layer of fiber bundles comprise separate, non-integrated elements.

In another preferred embodiment, the cushioning assembly comprises a bedding member.

### BRIEF DESCRIPTION OF THE DRAWINGS

The disclosure will now be described with reference to the drawings wherein:

FIG. 1 of the drawings is a cross-sectional view of a sample bedding (or other seating surface) contemplated by the present invention;

FIG. 2 of the drawings is a cross-sectional view of another sample bedding (or other seating surface) contemplated by the present invention;

FIG. 3 of the drawings is a cross-sectional view of another sample bedding (or other seating surface) contemplated by the present invention, showing, in particular, the heating and/or cooling (i.e., HVAC) incorporated therewith;

FIGS. 4a and 4b of the drawings are a cross-sectional view of multiple sample bedding (or other seating surface) contemplated by the present invention, wherein multiple embodiments are shown;

FIG. 5 of the drawings is a top plan view of another sample bedding (or other seating surface) contemplated by the present invention, showing, in particular, the positioning of different springs in a non-patterned configuration;

FIG. 6 of the drawings is a top plan view of another sample bedding (or other seating surface) contemplated by the present invention, showing, in particular, the formation of a single size, wherein the same can be cut to a desired shape and configuration; and

FIG. 7 of the drawings is a cross-sectional view of another sample bedding (or other seating surface) contemplated by the present invention, wherein the springs are encased (at least partially) in fiber bundles that are separate from the fiber bundles that form the top layer of material extending over the springs.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

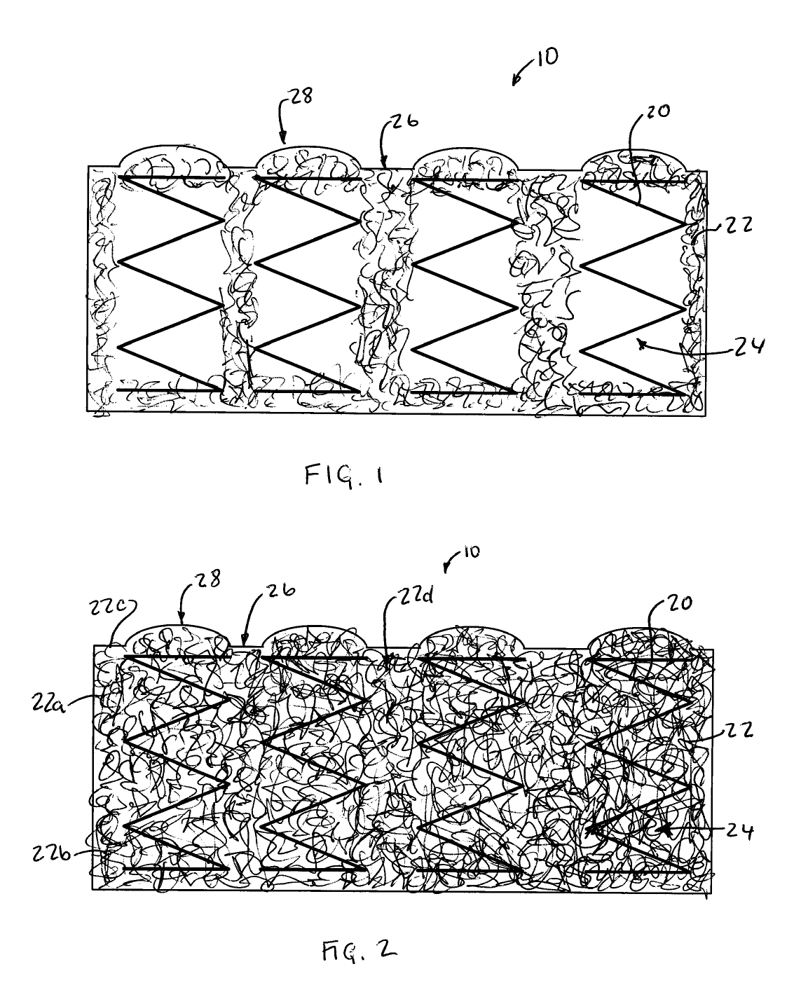

Referring now to the drawings and in particular to FIG. 1, the bedding assembly is shown generally at 10 (or, more broadly, a cushioning assembly—it will be understood that the term bedding shall apply to both conventional bedding as well as other cushioning assemblies, such as chairs, couches, sofas, and the like). It will be understood that each of the bedding concepts that will be described hereinbelow can be assembled through the utilization of processes, such as the process that is shown and described in U.S. patent application Ser. No. 12/004,560 filed Dec. 21, 2007, entitled “SYSTEM AND METHOD OF FORMING AN ARTICLE, AND AN ARTICLE FORMED THEREBY,” the entire specification of which is hereby incorporated by reference.

In one embodiment, with reference to FIG. 1, a plurality of springs 20 are spaced apart to define a matrix of springs. In the example shown, the springs are arranged in a substantially rectangular grid-like configuration. Fiber bundles 22 are blown into the springs until the fiber bundles are positioned between and around the springs. Through the method described in the incorporated patent application, these fiber bundles are then heated and compressed to melt the fiber bundles to each other and so as to integrate the fiber bundles with the springs. It will be understood that the springs are shown as being substantially uniform helically wound springs of a substantially uniform diameter. It will be understood that these are for illustrative purposes only and that it is contemplated that a number of different springs could be utilized, both helically wound springs, and the like. In addition, it will be understood that a number of different structures which have a biasing, spring-like effect can be utilized as well. This could include leaf springs, other materials, and other objects that have a spring (or biasing) effect.

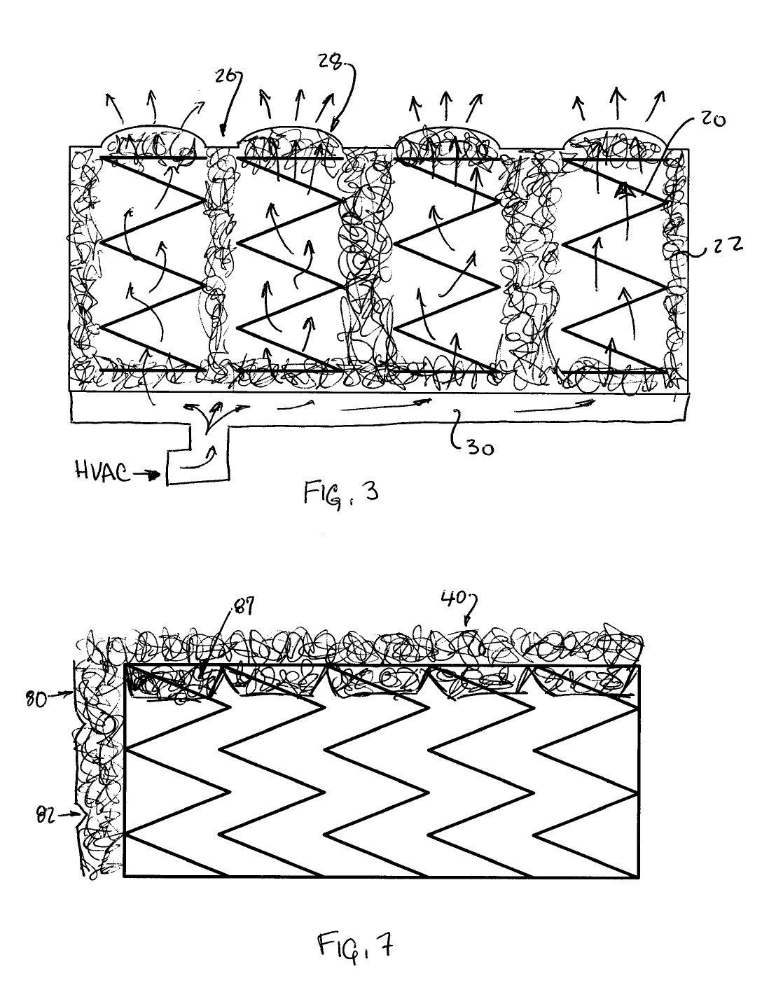

It will be understood that the fiber bundles can be positioned within the interior spring region 24 (FIG. 2), or in other embodiments, the interior spring region 24 can be maintained substantially free of fiber bundles (FIG. 1). With reference to FIG. 3, the interior spring region, where substantially free of fiber bundles, can be used as a conduit for heating and/or cooling air to be directed through the bedding. For example, a manifold 30 can be placed below the bedding with openings directed to the interior spring region. Thus, any forced air can, without major obstruction, proceed to the top surface of the bedding, to, in turn, efficiently heat or cool the same.

It will further be understood that in certain embodiments, it may be advantageous to preload the springs. This is done by compressing during the heating step so that the fibers can melt and integrate around a spring that has been compressed. Alternatively, the fibers can be heated and then preloaded after integration. For example, in certain embodiments that have been formed, a preload of 1″ on the springs was undertaken prior to introduction of the fiber bundles. Of course, other preloadings are contemplated for use in association with the present bedding, and the foregoing example is for illustrative purposes solely.

It will further be understood that any surface of the bedding can be modified and controlled with respect to surface topography. In the embodiment shown in attachment 1, the top surface 26 of the bedding includes bumps 28 that correspond in general to the placement of the springs. Such a configuration provides additional independent movement of the springs for the initial length of travel, corresponding to the height of the domes corresponding to the springs. In other embodiments, the fibers can be cut partially along the length of the spring to provide some independence.

It will also be understood that the fiber bundles can be varied throughout the bedding as desired. For example, and with reference to FIG. 2, throughout the thickness, the fiber bundles can be varied, from, for example, a more compressible fiber bundle 22a at or near the top of the bedding and a less compressible (more dense) fiber bundle 22b at or near the middle to lower parts of the bedding. Thus, as the user is heavier, a greater level of support is felt, without rendering too much support for a lighter user.

It will also be understood that the fiber bundles can be varied throughout the bedding at any given point. Thus, the edges of the bedding 22c can receive a less compressible fiber whereas the middle regions of the bedding 22d can receive a more compressible fiber. Other variations are likewise contemplated. In other embodiments, specific performance fibers (such as flame resistant fibers) can be integrated.

Advantageously, in such a configuration, fewer springs can be utilized than in a conventional bedding. In many instances half as many springs, or less can be utilized for a given application. Additionally, while the springs are coupled together by the fiber bundles so as to be a single integrated configuration, the springs can move without interfering with each other and substantially independent of each other when loaded. However, at the same time, the shifting movement of the springs is reduced, so that the springs travel in an up and down motion without much left to right shifting. It will further be understood that the position, placement, shape and orientation of the individual springs can be infinitely varied as the springs are not required to be coupled to each other in any particular configuration. Thus, various different springs can be utilized on the same bedding. For example, the bedding shown in FIG. 5 shows a number of springs 35 which are of different size, spring rate and which are positioned in a non-grid-like configuration. Moreover, the incorporating springs with the fibers allows for the improved performance of the fibers while minimizing any compression setting of the fibers (due to support by the springs).

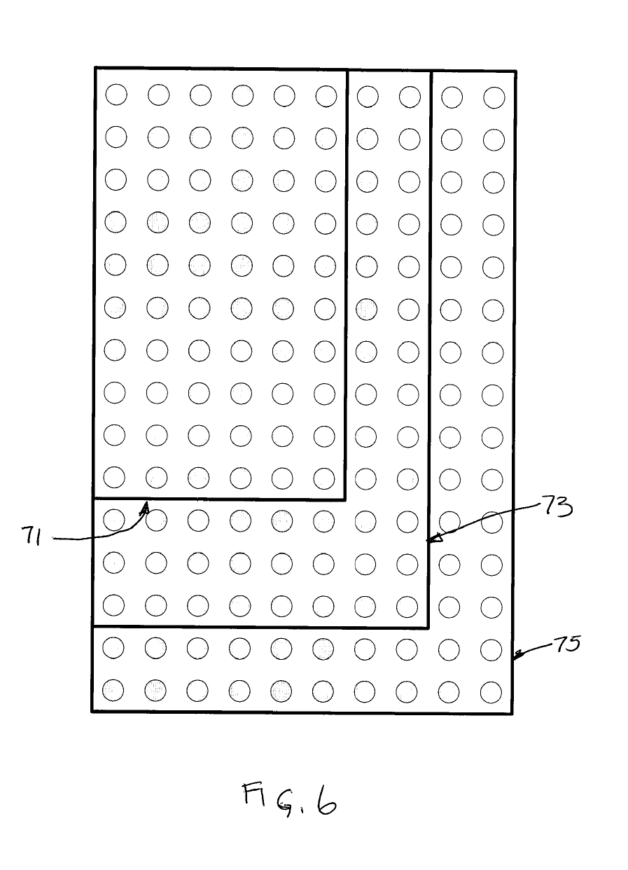

Such a structure, in certain embodiments, allows for the manufacture of a large sheet of bedding (or a continuous formation process) wherein the large sheet can then be cut into appropriately sized beds. For example, and with reference to FIG. 6, the large sheet may comprise a king size bed, which bed can then be cut into smaller sized beds, as needed, such as beds/cushions 71, 73 or 75. Inasmuch as no reinforcement is necessary about the outer perimeter of the bedding, the large sheet can be cut into any desired size and shape without affecting the performance thereof.

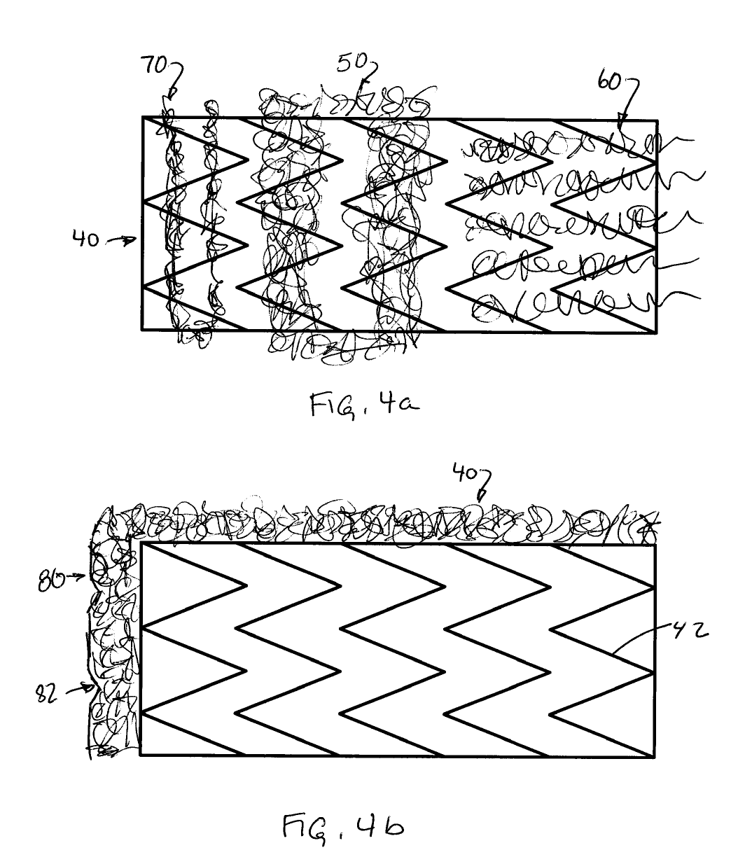

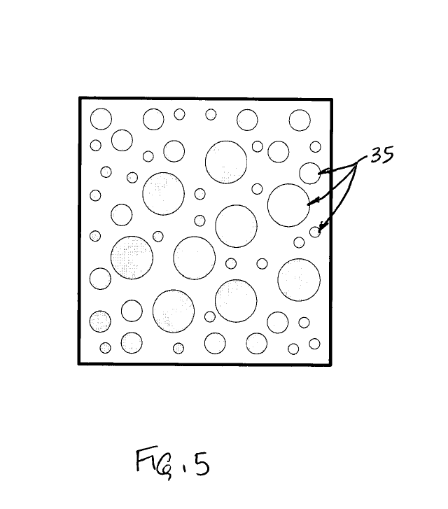

In another embodiment of the bedding, with reference to FIGS. 4a and 4b, the bedding may comprise a top layer of fiber bundles 40 of the type manufactured in accordance with the incorporated patent application. Below such a layer, a layer of springs 42 can be fitted and, in certain embodiments encased or restrained. In one such embodiment, in particular, and with reference to FIG. 7, portions of the springs (or the entirety of the spring) can be encased and restrained with fiber bundles 87 of the type manufactured in accordance with the incorporated patent application. These fiber bundles can be coupled to each other or separate from each other. Additionally, these fiber bundles can be separate from the fiber bundles that define the top layer of fiber bundles. Such a configuration allows for ease of manufacturing, and also allows for the use of different top layer fiber bundles in relation to the fiber bundles in the springs. In turn, a number of variations can be easily and quickly prepared, and customization can be more easily achieved.

In yet other embodiments, fiber bundles 50 can be introduced into the inner spring region of a conventional spring bedding 42. The fiber bundles can be varied that are introduced into each spring, and the fiber bundles can be varied in formulation throughout each individual spring. In other embodiments, the fiber bundles can encase individual springs or the entirety of a conventional spring bedding.

In still other embodiments, fiber bundles can be intertwined with the springs of a conventional spring bedding. For example, fiber bundles 60 (or in the form of fiber tows) can be extended laterally (i.e., side to side) through the coiled springs. In still other embodiments, fiber bundles (or in the form of fiber tows) 70 can be pulled through the central region of the spring. In such a configuration, the fiber tows are generally oriented in the same direction as the springs are intended to be displaced.

The fiber bundles 80 can also be utilized as extending around conventional spring bedding, or the bedding of any of the embodiments shown and described above. Such a configuration provides an improved edge around convention spring bedding. The fiber bundles 80 may include engineered portions, such as detents 82, which facilitate controlled deformation of the fiber bundles when compressed so that the fiber bundles deform in a controlled manner. Of course, other deformation means are likewise contemplated for use.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A cushioning assembly comprising:
a plurality of springs disposed at predetermined locations; and
fiber bundles cooperatively associated with the plurality of springs, wherein the fiber bundles are disposed into association with the plurality of springs, and subsequently integrated through a heating process with the plurality of springs and each other.

2. The cushioning assembly of claim 1 wherein the plurality of springs includes a first end and a second end, the fiber bundles coupling the first end of the springs and the second end of the springs.

3. The cushioning assembly of claim 2 wherein the plurality of springs further includes an inner spring region, the fiber bundles substantially precluded from being positioned within the confines of the spring.

4. The cushioning assembly of claim 2 wherein the plurality of springs are positioned substantially in a rectangular grid-like configuration.

5. The cushioning assembly of claim 3 further comprising a manifold coupled to an HVAC system, the manifold placed in communication with the inner spring region of the plurality of springs, to, in turn, provide conditioned air thereto.

6. The cushioning assembly of claim 1 wherein the plurality of springs comprise helically wound springs.

7. The cushioning assembly of claim 1 wherein at least one of the plurality of springs is preloaded.

8. The cushioning assembly of claim 1 further defining a top surface topography, the top surface topography having a plurality of bumps corresponding to the placement of the plurality of springs, to, in turn, facilitate the movement of the springs along an initial distance of travel substantially independently of other springs.

9. The cushioning assembly of claim 1 wherein the composition of the fiber bundles can be varied throughout the cushioning assembly.

10. The cushioning assembly of claim 9 wherein a more compressible fiber bundle is positioned in proximity of at least one of the edges of the cushioning assembly and wherein a relatively less compressible fiber bundle is positioned in a central region of the cushioning assembly.

11. The cushioning assembly of claim 1 wherein fiber bundles extending between respective ones of the plurality of springs can be cut to facilitate substantially independent movement of the respective ones of the plurality of springs.

12. The cushioning assembly of claim 1 wherein the fiber bundles comprise a plurality of fiber tows which are extended at least one of longitudinally and laterally through and between the respective ones of the plurality of springs.

13. The cushioning assembly of claim 1 wherein the fiber bundles extend about at least one end of the plurality of springs, with a top layer of fiber bundles extending over the at least one end of the plurality of springs, wherein the fiber bundles coupled to the springs and the top layer of fiber bundles comprise separate, non-integrated elements.

14. The cushioning assembly of claim 1 wherein the cushioning assembly comprises a bedding member.
